(19) United States
(12) Patent Application Publication
(10) Pub. No.: US 2006/0207321 A1
(43) Pub. Date: Sep. 21, 2006

(54) Level measurement device with a programmable module and programming terminal

(76) Inventors: Quinton Lyon, Peterborough (CA); Dominique Basson, Peterborough (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/082,568

(22) Filed: Mar. 17, 2005

(51) Int. Cl. G01F 23/00

(52) U.S. Cl. 73/290 V

(57) ABSTRACT

A level measurement apparatus for determining the level of a material received in a container is provided. The apparatus includes a transducer for emitting energy pulses and receiving reflected energy pulses, and circuitry operably coupled to the transducer. The circuitry includes a component for controlling the transducer. The circuitry also includes a component for determining level measurement based on the time elapsed between an emission of an energy pulse and a reception of the energy pulse reflected by the surface of the material. The apparatus also includes a programmable module operably coupled to the circuitry. The programmable module includes a component for receiving user programs for controlling the operation of the circuitry. Different embodiments of the level measurement apparatus, and a method and system for programming a level measurement apparatus are also provided.

### FIELD OF THE INVENTION

The present invention relates to level measurement devices, and more particularly to a level measurement system comprising a level measurement device with integrated programmability and a level measurement device programming system.

### BACKGROUND OF THE INVENTION

Pulse-echo ranging systems, also known as time-of-flight ranging systems, are commonly used in level sensing and level measurement applications. Pulse-echo ranging systems determine the distance to a reflective surface (i.e. reflector) by measuring how long after transmission of a burst of energy pulses the echoes or reflected pulses are received. Pulse-echo ranging systems typically use ultrasonic pulses or radar pulses or microwave signals.

Pulse-echo ranging systems are commonly used to measure the level of material within a vessel or container. These systems include a level measurement device or device comprising a housing and a waveguide such as a rod or a horn antenna, or for an ultrasonic implementation, an ultrasonic transducer. The level sensing or measurement device is typically mounted to the top of a vessel containing a material to be measured with the antenna (or transducer) extending into the interior of the vessel.

The level sensing or measurement device contains electronic circuitry for transmitting and receiving the signal, calculating the time elapsed between transmission and reception of the signal, and determining the distance to the surface of the material. Typically, the electronic circuitry includes a microcontroller and memory. The microcontroller operates under stored program control and typically includes one or more user configurable parameters.

Some level sensing and measurement device allow user requirements to be programmed into the device by adjusting configuration “parameters” which are accessed through a user interface (e.g. LCD display and keypad or input keys) on the device. The available configurable parameters are part of the device design. Adjustment of the parameters allows the user to adjust the response of the device to applications requirements (e.g. process conditions). Proper use of the device typically requires the user to learn many parameters. For some devices, seemingly unimportant parameters may be used in a way the user does not understand so proper training and education of the user is important. Because the configurable parameters available are determined at the design stage, a user may not need to access all of the configurable parameters available in some devices. In other cases, a user cannot achieve some configurations of the device using the built-in parameters of the control interface.

The development and support of level sensing and measurement devices is lengthy, often experiencing delayed product launch and requiring extensive support after launch. Further, the development of a new device requires large amounts of design and verification testing, for example when a new microcontroller is used. This is exacerbated by the inclusion of many user programmable parameters, each of which needs its algorithm integrated into the complex system of the device.

For some devices, parameter adjustment may also be accomplished by connecting the level measurement device to an external controller or computer such as a programmable logic controller (“PLC”) where its outputs are used for various purposes. The PLC or other controller receives and processes the device's measurements and outputs according to a user defined program. The output of this program is then used to implement various functions e.g. control functions. The user is able to define and implement a control strategy within the capabilities of the controller. Although a user can achieve some versatility with this approach, it is expensive in terms of purchase price, installation/support of additional equipment, and physical space. Further, the PLC typically has access to only the measurements and outputs of the level measurement device and does not have access to all of the configurable parameters of the device.

In other applications, a level measurement device may be directly connected to a device (e.g. pump) and the level measurement device itself is configured to control the device according to its measurements and outputs in a manner suited to the particular application. In this type of application, the user can set the configuration of the device using the various built-in features and configurable parameters of the device. However, the user has limited freedom in such applications because he or she cannot define the control strategy except as allowed by the built-in functions. Further, this type of device is relatively expensive in terms of purchase price.

Accordingly, there remains a need for a level sensing and measurement device providing improved adjustment of or access to device parameters for programming or reprogramming.

### SUMMARY OF THE INVENTION

The present invention provides a level sensing and measurement device having integrated programmability or programming function.

In another aspect, the present invention provides a level sensing programming terminal or level sensing programming development system for developing and downloading user programs or program or code segments to the level sensing device. The user programs provide the capability to adjust working parameters of the device, and are written, compiled, debugged and executed or emulated on the level sensing programmer or development system. In some embodiments, the user programs may include user-defined functions, scripts or control schemes. The level sensing programming system is operably connected to the device, for example, through a cable or an emulator interface, and the user programs are downloaded to the level sensing device to control its operation.

According to one aspect, the present invention provides a level measurement apparatus for determining the level of a material in a container, the apparatus comprises: a transducer for emitting energy pulses and receiving energy pulses reflected by the material; a module operably coupled to the transducer, the module including a component for controlling the transducer, and a component for determining level measurement based on the time elapsed between the emitted energy pulse and reception of the reflected energy pulse; and a programmable module operably coupled to the module, the programmable module including a component for receiving code for controlling the operation of the module.

According to another aspect, the present invention provides a method for programming a level measurement apparatus for determining the level of a material received in a container, the method comprises the steps of: setting the level measurement apparatus to an offline state; downloading a program to the level measurement apparatus; applying the program to a level measurement process stored in the memory of the level measurement apparatus; and setting the level measurement apparatus to an online state.

According to a further aspect, the present invention provides a system for programming a level measurement apparatus for determining the level of a material in a container, the system comprises: the level measurement apparatus including, a transducer for transmitting energy pulses and receiving reflected energy pulses; circuitry operably coupled to the transducer, the circuitry including a component for controlling the transducer, and a component for determining level measurement based on the time between the transmission of the energy pulse and reception of the reflected energy pulse from the material; a programmable module operably connected to the circuitry, the programmable module including a component for storing user programs for controlling the operation of the circuitry; and a terminal operably connectable to the level measurement apparatus, the terminal including a component for transmitting program code to the user programmable module, the terminal including a component for controlling the operation of the level measurement apparatus and a component for transferring the program code to the user programmable module.

According to yet another aspect, the present invention provides a computer program product for use with a computer to provide a programming apparatus for a level sensing device, the computer program product comprises: a recordable media having computer readable code embodied therein, for execution by the computer; code for entering program instructions for the level sensing device; code for communicating with the level sensing device; and code for transmitting the program instructions to the level sensing device.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Reference is next made to the accompanying drawings which show, by way of example, embodiments of the present invention and in which:

FIG. 1 is a schematic diagram of a level sensing device and programming system according to the present invention;

FIG. 2 is a schematic diagram of one embodiment of a level sensing device having integrated programmable facility according to the present invention;

FIG. 3 is a schematic diagram of another embodiment of a level sensing device having integrated programmability according to the present invention; and

FIG. 4 is a flowchart of a method for configuring a level sensing device according to the present invention.

### DETAILED DESCRIPTION OF EMBODIMENTS OF THE INVENTION

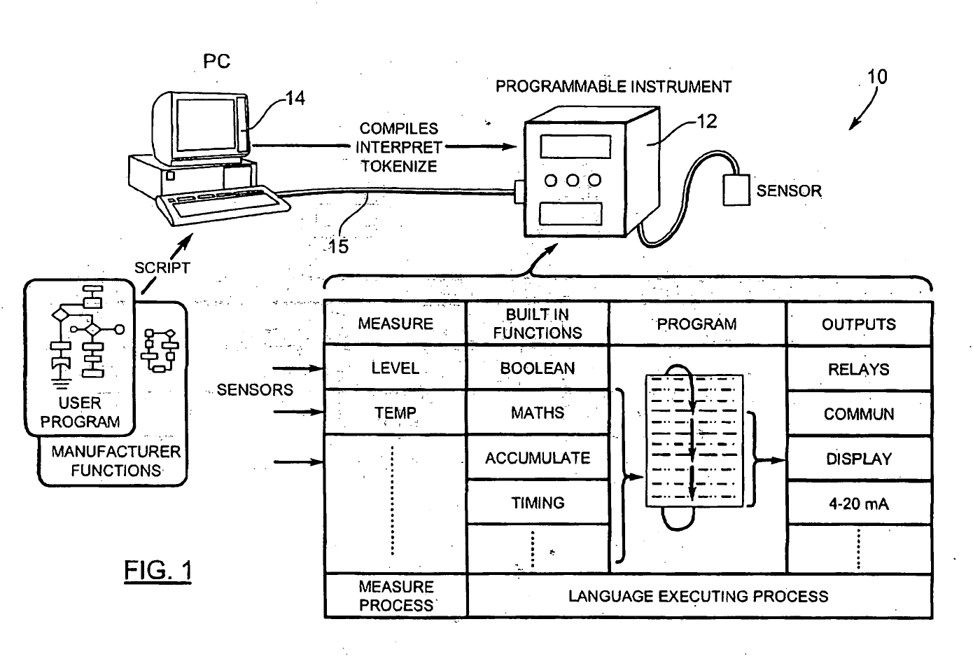

Reference is first made to FIG. 1, which shows in schematic form a level sensing device and programming system according to the present invention and indicated generally by the reference 10. The level sensing system 10 comprises a level sensing device 12 and a level sensing programming terminal or development system 14.

The level sensing programming terminal 14 may be implemented using a general purpose personal computer or PC which executes a computer program stored in memory or on a disk. The computer program embodies the features and functions as described in more detail below and may be provided as a software product for installation on a PC. In another embodiment, the level sensing programming terminal 14 may be implemented as a level sensing program development terminal. As will be described in more detail below, the level sensing program development terminal 14 operates under software control to provide a programming facility for writing, compiling, debugging and/or executing programs or code segments for controlling the level sensing device 12. As shown, the level sensing program development terminal 14 includes a cable, or other type of interface, indicated generally by reference 15 for connecting or coupling to a port 13 on the level sensing device 12. At the other end, the cable 15 is connected to an interface (e.g. PC) card on the terminal 14. The level sensing program or code segment(s) are downloaded to the level sensing device 12 through the interface cable 15. In another embodiment, the cable 15 may comprise an in-circuit-emulator interface for emulating and developing a level sensor application based on variable or adjustable operating parameters.

The level sensing programming terminal or development system 14 provides the facility for a user to write programs, code segments, or scripts on the terminal 14 using a predefined programming language. The program, code segment(s) or scripts are downloaded to the level sensing device 12 which includes a controller (e.g. microprocessor) which executes the program, code or script to control or augment or modify the operation of the level sensing device 12. The user program (code segments or scripts) may include control functions, measurement functions and other functions such as alarms. The user program may modify device parameters. In developing the user program, the user may define new functions or use built-in functions supplied by the manufacturer (for example, a function library installed or downloaded from a disk or the Internet) of the level sensing device 12. The user may also modify application functions provided by the manufacturer, if desired. Conventional built-in functions may be retained in the level sensing device 12 or they may be provided as downloadable functions that the user may acquire, if desired from a library of functions accessible on the level sensing programming terminal 14. For example, the level sensing programming terminal 14 may be provided with a number of device configurations with different parameter and function presets for use in different applications. When a different configuration for the level sensing device 12 is desired, the device configuration is downloaded to the device, to adjust device parameters and/or functions.

The level sensing programming terminal 14 may be implemented with a standardized programming language, for example according to the IEC61131 standard or the BASIC™ programming language. The program is downloaded to and executed by the level sensing device 12 as a script, i.e. an uncompiled program. In another embodiment, the level sensing programming terminal 14 includes a source code editor and compiler for writing and compiling the source code into object code which is compatible with the microcontroller or microprocessor in the level sensing device 12. The object code is downloaded to the level sensing device 12 and stored in non-volatile memory for execution by an on-board microprocessor. The level sensing programming terminal 14 may include an emulator for emulating and/or debugging the code on the terminal 14 and/or in the level sensing device 12.

As described above, the programming language and nature of the user programs may take the form of a compiled program or an “interpreted” or uncompiled program, or a program having a combination of features of both program types. As will be appreciated by persons skilled in the art, complied programs are programs which have been reduced to a set of machine-specific instructions (e.g. object or machine code) stored in an executable format. Interpreted programs are stored in the same format in which they were created and must be compiled or converted to machine instructions at runtime. Each type of program has its own advantages. For example, compiled programs generally run faster than interpreted programs because they do not need to be compiled at runtime. However, interpreted programs provide options which are not available for compiled programs. For example, interpreted programs are modifiable by adding or changing functions at runtime. In some embodiments, interpreted programs modify their own programming at runtime.

The user programs are transferred or downloaded from the level sensing programming terminal 14 to the level sensing device 12 for execution. For uncompiled or interpreted language programs, the user programs are typically executed using an interpreter or similar built-in process.

According to one aspect, the level sensing device 12 executes the downloaded user program(s) while at the same time, invisible to the user, it executes its measurement functions'using any user modified configuration parameters. The level sensing device 12 also continually updates variables which may be needed by the user program. The level sensing device 12 then executes output functions. The output functions may be implemented according to the user program, for example, using built-in or library functions from the level sensing programming terminal 14.

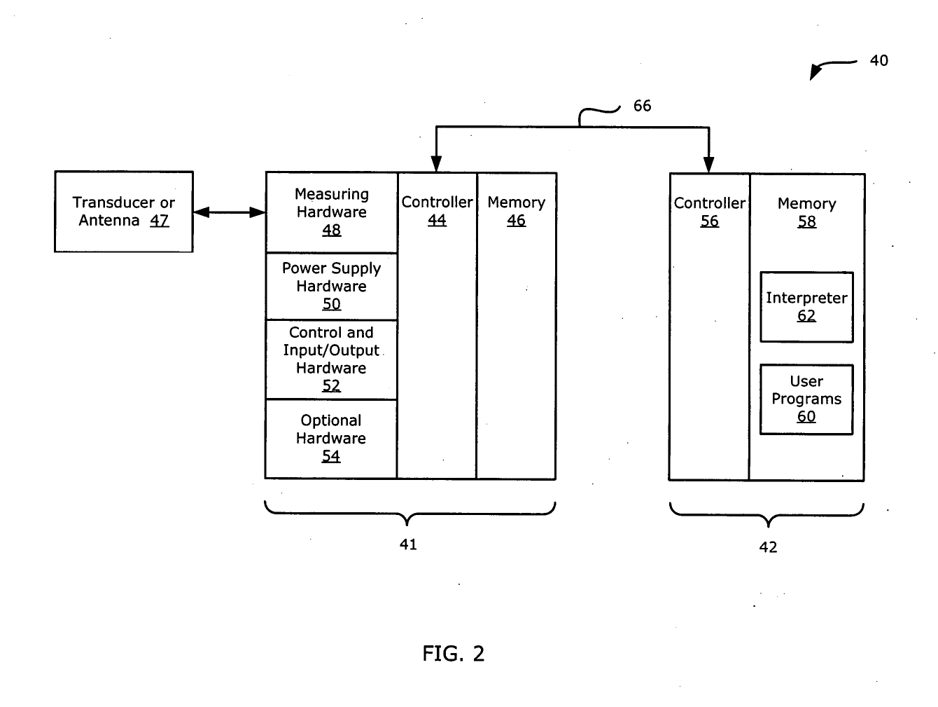

Reference is next made to FIG. 2, which shows an embodiment of a level sensing device 40 having a user programmable module 42 for implementing or providing an integrated programmable facility according to the present invention. According to this aspect, the user programmable module 42 is linked to conventional measurement and associated module or electronic circuitry 41 of the level sensing device 40 in a manner by which the module 42 has access to the level sensing configuration parameters and output hardware.

The module 41 comprises a controller 44, for example, a microcontroller or microprocessor, memory 46, a transducer or antenna 47, interface circuitry 48 between the microcontroller 44 and transducer 47, a power supply 50, input, output and/or bidirectional ports 52, and optional hardware 54 for providing additional functionality. The microprocessor or microcontroller 44 executes a program or programs stored in the memory 46 to perform the functions associated with level sensing functions. The interface circuitry 48 comprises electronic components for interfacing the input/output control ports 52 on the microcontroller 44 with the transducer or antenna 47. The power supply 50 may include a power management component (not shown) which may be operated independently or under microprocessor control.

The microcontroller 44 executes a program to control the system hardware, user interface and level measurement processing. The memory 46 includes data memory (e.g. RAM), program memory (e.g. EEROM), or non-volatile rewritable memory for storage of user, process data and the user program or code segments. The memory 46 may be included in the microcontroller 44 as an “on-chip” resource, or may be implemented as one or more discrete components coupled to the microprocessor 44. The transducer 47 comprises an ultrasonic transducer or an antenna (i.e. rod or horn). The input/output ports 52 control devices such as a LCD display, a communication interface, a keypad, and/or a current loop interface. The input/output ports 52 are operated under microprocessor 44 program control. The optional hardware 54 may include temperature sensors, self-diagnostics, real time clocks, timers and counters, and reset circuitry, which operate under the program control of the microprocessor 44.

As depicted in FIG. 2, in one embodiment, the user programmable module 42 comprises a user programmable microcontroller or microprocessor 56 for executing user programs (e.g. downloaded from the level sensing programming terminal 14—FIG. 1), and memory 58 for use by the microcontroller 56. The memory 58 includes RAM, EEROM, and non-volatile rewritable memory. One or more user programs, or code segments, 60 are stored in the memory 58. The user programs 60 may be in executable format or may require further processing prior to execution. The user programmable module 42 may also include an interpreter component for converting interpreted programs into an executable format. In another embodiment, the interpreter component may also execute interpreted programs after conversion. As depicted in FIG. 2, an interpreter program 62 is stored in the memory 58. The interpreter program 62 comprises a BASIC™ kernel and the user programs 60 are written in the BASIC™ programming language.

Referring to FIG. 2, a communications link or channel 66 is provided between the microcontrollers 44 and 56 to allow the user programmable microcontroller 56 to access device variables and configuration parameters stored in the module 41, e.g. from the memory 46. For example, under the control of the level sensing programming terminal 14 (FIG. 1), a user program downloaded to the device, or using the LCD display and keypad, the user accesses device parameters and variables (such as the last measurement value, time information, error codes, outputs and inputs) in the user program in a convenient and user-friendly manner that provides ease of control of the level sensing device 40.

The microcontroller 56 executes the user programs 60. In one embodiment, the user program or code 60 is executed by the interpreter program 62. The programming language understood by the microcontroller 56 and the interpreter program 62 may be one of the languages described above or another suitable language. Examples of suitable programming languages include Forth, Small C, Modula2, Structured Text (a Pascal-like textual programming language), Instruction List (an assembler type textual programming language), Ladder Diagram (a common programming language for PLCs which depicts relays and coils that which can be combined using Boolean AND, OR and other operations), Function Block Diagram (a graphical form of interconnecting functions and function blocks to create the desired behaviour. Unlike ladder logic, the data passing between outputs and inputs of function blocks may have various data type), Sequential Function Chart (is designed to program sequential controls such as may be found in batching processes), a scripting language (many scripting languages exist or can be written, these have little definition except that they execute instructions in a script which is available to it) or combinations of two or more of the examples mentioned above or derivatives thereof (for example, not every version of BASIC™ is the same, some have customized functions appropriate for the particular hardware or application). In another embodiment, the user program 60 is written in the native language of the device components.

The configuration of the level sensing device 40 may be varied from that shown in FIG. 2. The user programmable module 42 may be more extensive in its implementation. In one embodiment, some of the device control functions are transferred from the module 41 to the user programmable module 42. For example, the user programmable module 42 provides the communications or display functions, or the real-time clock is present in the user programmable module 42. In another embodiment, the relays are only coupled to the user programmable module 42. Any number of similar variations may be made to the user programmable module 42 according to considerations of upgradeability, support, complexity, design times and cost, among other factors.

In another embodiment, the functionality of the user programmable module 42, i.e. microcontroller 56 is integrated with the microcontroller 44. The downloaded user programs or code segments 60 are stored in the memory 46 which is accessed by the microcontroller 44.

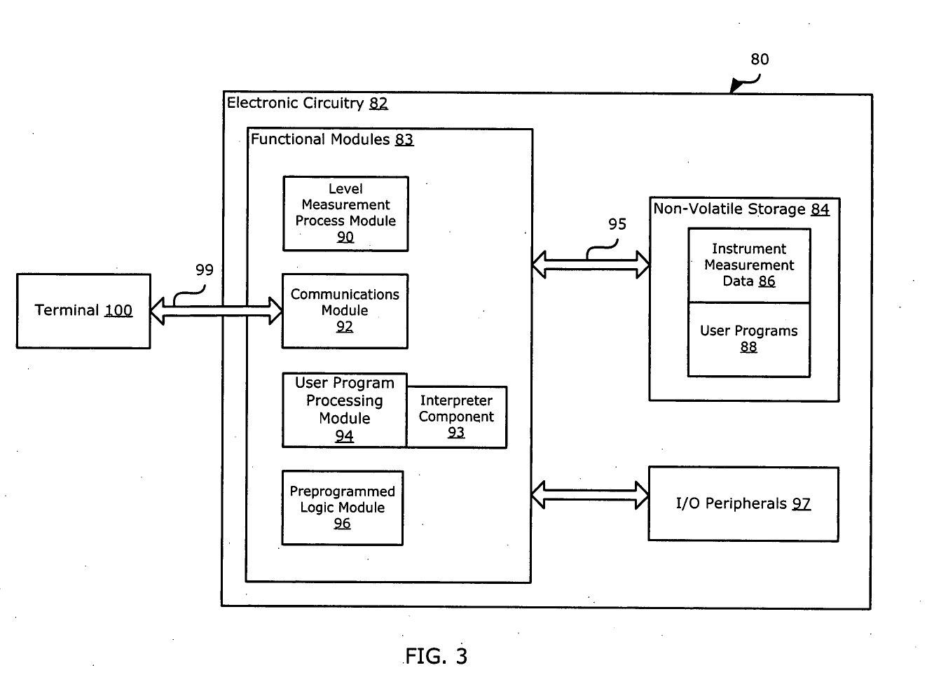

Reference is next made to FIG. 3, which shows another embodiment of a level sensing device 80 having integrated programmability according to the present invention. As shown, the level sensing device 80 includes measurement and electronic circuit 82 similar to the module 41 described above with reference to FIG. 2. The electronic circuit 82 comprises a microcontroller or microprocessor, hardware or circuit elements, and memory. The memory includes RAM, EEROM, and non-volatile rewritable memory 84 for storage of user and process data. Device and measurement data 86 including device configuration and runtime parameters are stored within the memory e.g. non-volatile rewritable memory 84. One or more user programs 88 are stored within memory e.g. non-volatile rewritable memory 84. The user programs 88 may be in executable format or may require further processing prior to execution.

The electronic circuit 82 includes functional modules 83 for performing various functions associated with the level sensing device 80. The functional modules 83 may be implemented in the form of program components (e.g. software functions) which are stored in memory and executed by the microprocessor. The electronic circuit 82 includes a level measurement process module 90 for performing level measurement functions, a communications module 92 for providing a communications interface with an external terminal or device 100, a user program processing module 94 for executing user programs, and a pre-programmed logic module 96. As shown in FIG. 3, in one embodiment, the user program processing module 94 includes an interpreter component 93, for example, an interpreter program for converting interpreted programs into an executable format. In another embodiment, the interpreter component 93 also executes interpreted programs after conversion. For example, the interpreter program is a BASIC™ kernel and the user programs 88 are written in the BASIC™ programming language.

A communications bus, channel or link 95 between the user program(s) 88 and the functional modules 83 provides the user programs 88 with access to the level sensing configuration parameters and output hardware.

The level sensing device 80 executes the user program(s) 88 stored in memory 84 while at the same time, invisible to the user, it executes its own level measurement functions using user modified configuration parameters. The device 80 also continually updates variables which may be needed by the user program 88. The level sensing device 80 then executes output functions. The output functions are implemented according to the user program 88, for example, using built-in functions.

The user program processing module 94 reads user programs 88 from memory, e.g. non-volatile rewritable memory 84, and is also able to read and write device configuration parameters, and to read runtime data related to the measurement.

The user program processing module 94 typically operates concurrently with other processes/threads in the device 80. Typically, both the user program 88 and level measurement functions are executed in a near simultaneous manner. Depending on the type of program and programming language implemented by the device, execution of user programs 88 may include compilation, just-in-time compilation, interpretation or other execution mechanism.

The pre-programmed logic module 96 includes some pre-configured logic (e.g. common alarm control) and provides other components that user programs 88 use as resources (e.g. different timer configurations). The pre-programmed logic module 96 may also include components (e.g. software components such as peripheral interface software) to interact with input/output peripherals 97 of the device 80. The peripherals 97 may be controlled or read by user programs 88. In some embodiments, the pre-programmed logic module 96 may provide user programs 88 with access to Analog-to-Digital converters (e.g. mA loops), Digital-to-Analog converters (e.g. Temperature sensors) and discrete input and output devices (e.g. contact switches and relays).

As described above, the level sensing device 80 is operably connected to the level sensing programming terminal 14 (FIG. 1). The downloading and updating of user programs or code segments requires a consideration of how modification of the logic of the device will affect any active measurement and control functions. In particular, downloading and updating user programs requires consideration of any controls that are currently in place, the potential impact on process control during the update, and the impact on SCADA systems (Supervisory Control And Data Acquisition system) or other process control software that may require access to the communication channel to the device. The last issue is of significance for level sensing devices with a single communications channel.

For a level sensing device 12 with active controls in place, the device should be set offline while the new user program or script is uploaded. Controlled items such as pumps, valves, gates, and other components should be placed in a suitable condition to minimize the risk of damage to the system. The level sensing device 12 may be implemented in a system having backups to maintain control while the device is offline.

Controlling the impact the control system requires the device 12 to be disconnected from the control system or network in which it is implemented, or that the level sensing device 12 and network support multiple controllers. If the device supports multiple controllers, then it must be “locked” to the updating controller to prevent conflicting programming while it is being updated.

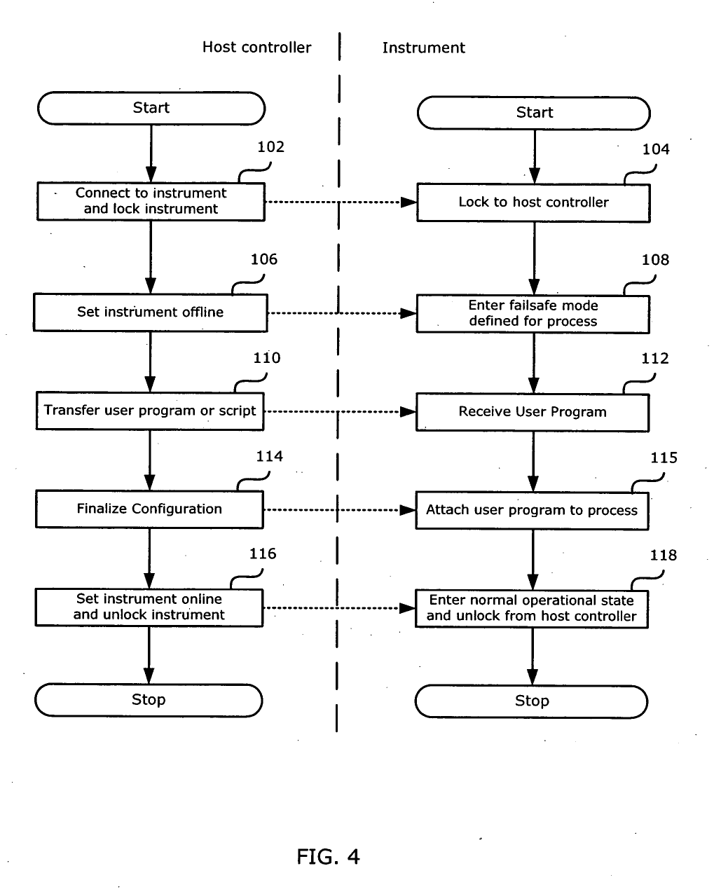

Reference is made to FIG. 4, which shows a method for safely updating user programs in a level sensing device 12 (FIG. 1) operating in a multiple controller environment according to another aspect of the invention and indicated generally by reference 101. Dotted lead lines are used to indicate communications or data transfer between a host controller (e.g. the level sensing programming terminal 14) and the level sensing device 12. The method 101 may be adapted to the specific configuration of the level sensing device 12.

First in step 102, the controller seeking to load or update one or more user programs on the level sensing device 12 (FIG. 1) makes a connection to the device and locks it so that other controllers (e.g. terminal 14) may not modify the device configuration. The level sensing device 12 then enters a locked state (step 104). The connection between the terminal 14 and the device 12 is provided by the interface cable 15 (FIG. 1) or via a wireless link or connection.

Next in step 106, the terminal 14 instructs the device 12 to go offline. The device 12 then enters an offline state and the device 12 outputs go to a failsafe state (step 108). This state will be recognized by other controllers (e.g. terminals 14) on the network (if they exist) and/or allow secondary (alternate) control mechanisms to take over control functions while the device 12 is offline.

Next in step 110, the terminal 14 downloads or transfers the new user program, script or code segment(s) to the device 12. The new user program or script is received by the device 12 and stored in memory e.g. non-volatile rewritable memory (step 112).

Next in step 114, the controller or terminal 14 instructs the device 12 to enable the user program or script to become a part of the control process and finalize the configuration for the device 12. The level measurement process then attaches the new user program or script (step 115).

Next in step 116, the controller (i.e. the terminal 14—FIG. 1) instructs the device 12 to go online and the controller 14 unlocks itself from the device 12. The device 12 then enters an online state and resumes normal operation (step 118). The device 12 outputs return to a normal operational state which will be recognized by other controllers 14 on the network (if they exist) and allow any secondary (alternate) control mechanisms which were implemented to relinquish control.

The present invention provides programmable level sensing and measurement devices. User defined programs or scripts may be written, downloaded, and stored within the memory of the device. User programs may have access to the complete working parameter set of the device. This allows the user to develop a program or algorithm using any working parameter of the device. In addition, user programs are also able to directly modify the working parameters of the device. This is particularly useful when the program or algorithm wants to modify device behaviour based on specific operating conditions. Further, because user programs operate internally, they are not limited by the speed or state of external network connections. Control is potentially faster and independent, thereby improving reliability.

Other potential advantages of the programmability provided by the present invention include: a reduction in development and verification testing times; improved use of hardware resources such as memory and speed by eliminating unneeded functions; simplified fault detection for user defined programs and functions, for example using debugging software on an external terminal; upgradeability and versatility; and reduced requirements for manufacturer support owing to reduced built-in functionality of the device.

While described in the context of an ultrasonic pulse, radar pulse or microwave based time-of-flight or level measurement application, the apparatus and techniques according to the present invention also find application in a FMCW radar level transmitter system. FMCW radar level transmitter systems transmit a continuous signal during the measurement process. The frequency of the signal increases or decreases linearly with time so that when the signal has travelled to the reflective surface and back, the received signal is at a different frequency to the transmitted signal. The frequency difference is proportional to the time delay and to the rate at which the transmitted frequency was changing. To determine the distance that the reflector is away from the radar transmitter, it is necessary to analyze the relative change of the received signal with respect to the transmitted signal as will be appreciated by those skilled in the art.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather the foregoing description, and all changes which come within the meaning and range of equivalency of the claims are therefore intended to be embraced therein.

What is claimed is:

1. A level measurement apparatus for determining the level of a material in a container, said apparatus comprising:
a transducer for emitting energy pulses and receiving energy pulses reflected by the material;
a module operably coupled to the transducer, the module including a component for controlling the transducer, and a component for determining level measurement based on the time elapsed between the emitted energy pulse and reception of the reflected energy pulse; and
a programmable module operably coupled to the module, the programmable module including a component for receiving code for controlling the operation of the module.

2. The level measurement apparatus as claimed in claim 1, further comprising a program component for executing the code in the programmable module.

3. The level measurement apparatus as claimed in claim 2, wherein the program component executes compiled programs, interpreted programs or combinations thereof.

4. The level measurement apparatus as claimed in claim 3, wherein the program component includes an interpreter component for converting interpreted programs into a format executable by the program component.

5. The level measurement apparatus as claimed in claim 1, wherein the programmable module comprises a microcontroller and memory for storing the code.

6. The level measurement apparatus as claimed in claim 5, wherein the program component for executing programs is provided in the programmable module.

7. The level measurement apparatus as claimed in claim 5, further comprising a link between the module and the microcontroller in the programmable module, the link providing the programmable module with access to parameters for the apparatus.

8. The level measurement apparatus as claimed in claim 7, wherein the module includes a controller and memory, the link operably coupling the microcontroller of the programmable module to the controller and memory in the module.

9. The level measurement apparatus as claimed in claim 8, wherein the link provides the programmable module with access to process data stored in the memory in the module.

10. The level measurement apparatus as claimed in claim 8, further comprising a program component for reading and writing apparatus parameters to the memory in the module.

11. The level measurement apparatus as claimed in claim 10, further comprising a program component for reading runtime data related to level measurement operations performed by the apparatus.

12. The level measurement apparatus as claimed in claim 1, wherein the module includes a program module for executing user programs.

13. The level measurement apparatus as claimed in claim 12, wherein the program module includes means for executing compiled user programs, interpreted user programs or combinations thereof.

14. The level measurement apparatus as claimed in claim 13, wherein the program module includes an interpreter component for converting interpreted user programs into a format executable by the user program processing module.

15. The level measurement apparatus as claimed in claim 12, wherein the program module includes a program component for reading or writing apparatus parameters.

16. The level measurement apparatus as claimed in claim 13, wherein the program module includes a program component for reading data related to level measurement operations performed by the apparatus.

17. A method for programming a level measurement apparatus for determining the level of a material received in a container, said method comprising the steps of:
setting the level measurement apparatus to an offline state;
downloading a program to the level measurement apparatus;
applying the program to a level measurement process stored in the memory of the level measurement apparatus; and
setting the level measurement apparatus to an online state.

18. The method as claimed in claim 17, further comprising the steps of:
determining if the level measurement apparatus has active associated control processes; and
if the level measurement apparatus has active control processes, implementing alternate control mechanisms for the control processes.

19. The method as claimed in claim 18, further comprising, after the step of applying the program to a level measurement process stored in the memory of the level measurement apparatus, before the step of setting the level measurement apparatus to an online state, the step of:
deactivating any alternate control mechanisms for the control processes.

20. A system for programming a level measurement apparatus for determining the level of a material in a container, said system comprising:
the level measurement apparatus including:
a transducer for transmitting energy pulses and receiving reflected energy pulses;
circuitry operably coupled to the transducer, the circuitry including a component for controlling the transducer, and a component for determining level measurement based on the time between the transmission of the energy pulse and reception of the reflected energy pulse from the material;
a programmable module operably connected to the circuitry, the programmable module including a component for storing user programs for controlling the operation of the circuitry; and
a terminal operably connectable to the level measurement apparatus, the terminal including a component for transmitting program code to the user programmable module, the terminal including a component for controlling the operation of the level measurement apparatus and a component for transferring the program code to the user programmable module.

21. The system as claimed in claim 20, further comprising a program component for editing and fault checking the program code.

22. A computer program product for use with a computer to provide a programming apparatus for a level sensing device, said computer program product comprising:
a recordable media having computer readable code embodied therein, for execution by the computer;
code for entering program instructions for the level sensing device;
code for communicating with the level sensing device; and
code for transmitting the program instructions to the level sensing device.

23. The computer program product as claimed in claim 22, wherein said code for entering program instructions includes code for editing said program instructions.

24. The computer program product as claimed in claim 23, wherein said code for entering program instructions includes code for compiling said program instructions.

25. The computer program product as claimed in claim 22, further including an emulator for emulating a level sensing device, said emulator being responsive to one or more of said program instructions.
